(19) United States
(12) Patent Application Publication
(10) Pub. No.: US 2011/0035977 A1
(43) Pub. Date: Feb. 17, 2011

(54) TECHNIQUE FOR INCREASING SIGNAL VISIBILITY

(75) Inventors: Christopher Wilson, Lachine (CA); Mark Mayer, Sagamore Hills, OH (US); Eden Dubuc, St. Michael (CA); Yuandong Ma, Lachine (CA); Luc Cloutier, Lachine (CA)

Correspondence Address: FAY SHARPE LLP, 1228 Euclid Avenue, 5th Floor, The Halle Building, Cleveland, OH, 44115, US

(73) Assignee: LUMINATION LLC, Valley View, OH (US)

(21) Appl. No.: 12/666,037

(22) PCT Filed: Jun. 25, 2008
(86) PCT No.: PCT/US2008/068125

§ 371 Date: Jun. 21, 2010

Related U.S. Application Data
(60) Provisional application No. 60/946,019, filed on Jun. 25, 2007.

(51) Int. Cl. G09F 13/16; F21V 7/00

(52) U.S. Cl. 40/582; 362/296.01; 362/235

(57) ABSTRACT

A lamp assembly with a solid, opaque panel perforated by at least one aperture producing a silhouetted symbol representative of a traffic or pedestrian message and a reflective coating affixed to the light-facing inner side of the panel that reflects light. The lamp assembly further includes at least one optical element that scatters the reflected light through the mask at a plurality of angles relative to the path of the emitted light passing directly from the light source and a low reflective, dark colored layer affixed to the outer side of the mask in order to provide contrast with the light passing through the pattern of apertures.

### BACKGROUND

The present invention relates to the field of reflective coatings as applied to a lamp assembly and to the improved functional performance of the coated lighting assembly. It finds particular application in conjunction with traffic signals and will be described with particular reference thereto. However, it is to be appreciated that the present invention may also be amenable to other applications.

By way of background, a lamp assembly (e.g., a full ball traffic signal) may include a mask that displays a portion of the emitted light from the light source to an observer while also blocking other portions of the emitted light from reaching the observer. In this case, the light source may comprise an incandescent light bulb (or lamp) or LEDs—light emitting diodes. In the present state of the art, masks are generally applied to the interior or exterior surface of the outer shell of the traffic signal. Such a mask includes light-transmissive portions that allow light to pass through, and opaque portions that prevent light from passing through. The open portions that allow light to pass through may be formed into a pattern such that the light passing through the light-transmissive portions may project an image or symbol to an observer at a distance from the masked full ball. The traffic signal may also have a removable mask wherein the mask may have openings, through which light passes to the observer and appears as a light pattern or silhouette in the shape of the open portion of the mask. Masks can be used to define various types of symbols, such as pedestrian signals, arrows, or custom signals.

What the current prior art is presently lacking is a mask that does not require the addition of any extra components in order to improve the illuminated appearance of the signal aspect and does not interfere in any way with the projection of the full ball signal through the mask aperture. The field would benefit from an invention that eliminates the need for intermediate optics or diffuse surfaces that would vastly reduce overall system efficiency.

### BRIEF DESCRIPTION

In accordance with an aspect of the present exemplary embodiment, a reflective coating is applied to the inside of a mask in a lamp assembly. The reflective inner surface redirects light impinging on the surface of the mask back into the body of the lamp assembly. Light is scattered by the optical elements of the lamp assembly and bounces or is reflected between various lenses and surfaces of the interior of the lamp assembly and the reflective coating on the mask until the light escapes through the signal cut-out of the mask. The light that escapes in this way is emitted at broader angles as opposed to the light which escapes the lamp directly and emitted in a beam pattern dependant on the specific full-ball lamp being masked. Since light from each part of the symbol is directed at broader angles, the symbol becomes brighter and more fully visible from off-axis angles. This is in contrast to conventional means wherein the only viewable aspect is the light output of the full-ball modified by the presence of the symbol cut-out.

The reflective coating on the mask may consist of white or silver paint, which can be hand-painted on mask by a number of ways including spray painting, argent paint, vacuum-deposited metallization, co-molding, in-mold decoration, or lamination. Thus, in accordance with the exemplary embodiment, the mask is a thin opaque part that is black on one surface and reflective either in a specular or diffuse way on the other.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a graphical representation of a few of the typical masks used in traffic signals;

FIG. 2 is an illustration of three observers viewing the same mask covered lamp assembly from three different angles;

FIG. 3 is an illustration of a mask covered lamp assembly without any reflective coatings;

FIG. 4 is an illustration of a mask covered lamp assembly with a reflective coating applied to the mask;

FIG. 5 is an illustration of a detailed view of reflective surfaces reflecting light from the lamp assembly through openings in a mask;

FIG. 6 is an illustration of the improved performance resulting from application of the mask in accordance with aspects of the exemplary embodiments; and

FIG. 7 is an illustration of a traffic signal, in accordance with aspects of the exemplary embodiments.

### DETAILED DESCRIPTION

As used herein a “lamp assembly” generally refers to a full ball traffic signal. However, it is to be understood that other types of lamp assemblies may be contemplated.

Further, as used herein a “mask” generally refers to a pattern formed by least one light transmitting opening in a surrounding opaque material. The present embodiments are based on a mask that consists essentially of a solid, opaque panel perforated by at least one opening cut out through the entire thickness of the panel. The perforations may be arranged in a silhouette pattern that resembles a picture, word, icon, or other relevant symbol that is intended to communicate a relevant message when interpreted by a viewer.

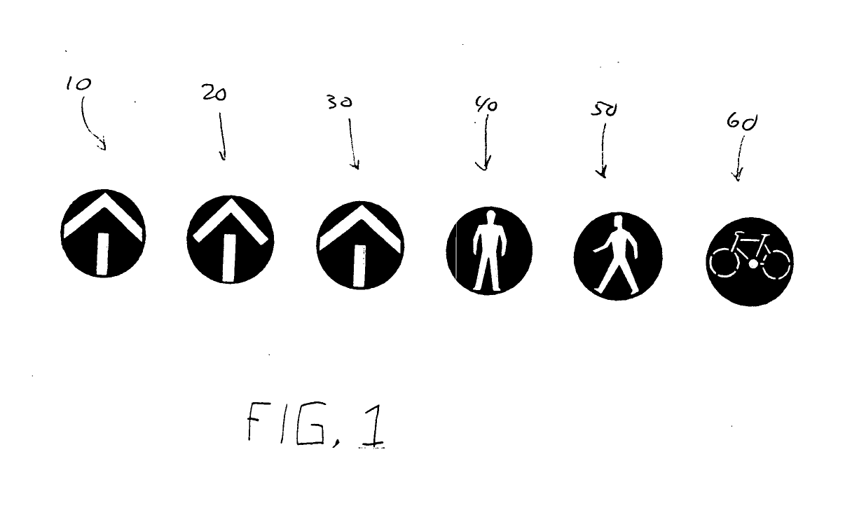

Referring now to the drawings wherein the showings are for purposes of illustrating the exemplary embodiments only and not for purposes of limiting the claimed subject matter, as shown in FIG. 1, such masks can be used to define a number of traffic signals, including, but not limited to, arrows (10, 20, 30), pedestrian controls (40, 50), a bicycle 60, and others. The symbols described herein with respect to the exemplary embodiments are generally traffic-related; however, the exemplary embodiments may work equally well with other types of symbols.

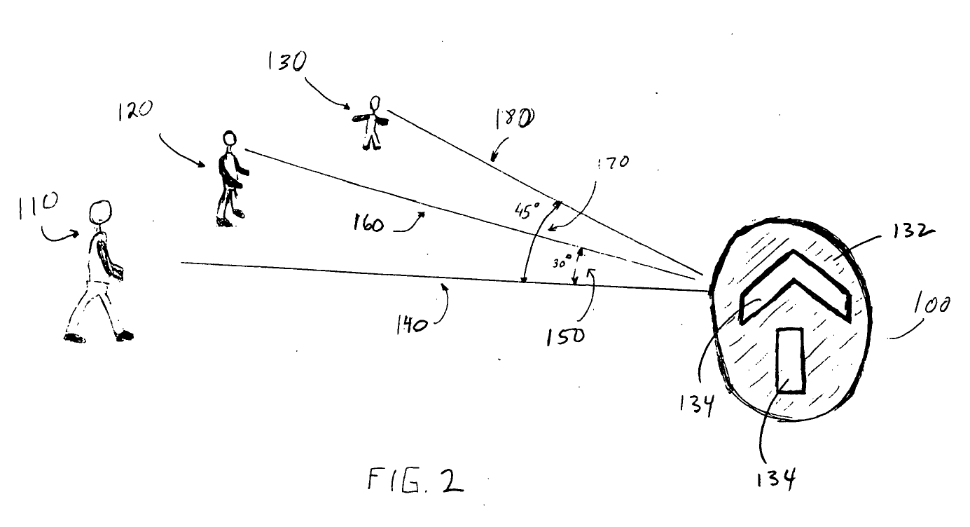

We turn now to FIG. 2, which is an illustration of a masked lamp assembly 100 as viewed by three observers 110, 120, 130 from various angles. A mask 132 has been placed in front of the lamp assembly 100 such that the light passes through only the pattern openings 134. Light may be emitted in a plurality of directions. The first observer 110 facing the lamp assembly 100 head-on will perceive the maximum amount of light 140. This is because the first observer 110 receives direct light waves, and there is little deflection of the light due to interference of the mask 132 located between the observer and the lamp assembly 100. This position is known as being head on or on-axis to the light source. The second observer 120 views the same lamp assembly 100 from a slightly askew angle 150 such as 30 degrees and perceives less light 160 than the first observer 110. Such a position is known as being off-axis. As the askew angle 170 increases to say 45 degrees, progressively less light 180 will be perceived by the third observer 130 such that he may not be able to interpret the meaning of the symbol projected by the lamp assembly 100.

A masked lamp assembly forms a symbol that can best be seen and interpreted when viewed from a position directly in front of the lamp assembly or on-axis. When the viewer moves away from and to the side of the lamp assembly, moving laterally off-axis, the intensity and clarity of the signal progressively loses its uniformity until at wide enough angles, the pattern in the signal is lost. When the symbol becomes unrecognizable, the symbol is no longer able to be interpreted by the user and thus the meaning of the symbol is lost.

What is therefore needed is a means for making the light viewable and the signal interpretable to an observer viewing the light at various angles. This could most readily be accomplished by increasing the apparent light output from the masked lamp assembly, thus increasing the light perceived by the observer. One means for accomplishing an apparent increase in light output is to reflect a portion of the light currently being absorbed by the mask. Such reflection may also serve the secondary purpose of dissipating heat generated by absorbing light.

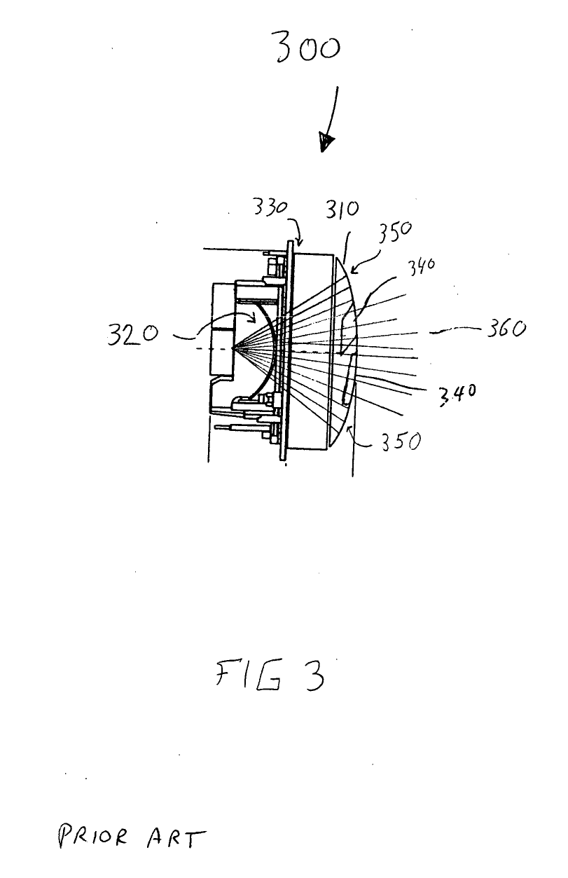

FIG. 3 shows a prior art assembly 300. A mask 310 operates to selectively block or pass light beams from a light source. When the mask 310 is placed in front of a light source 320 and held securely by connecting or fastening means 330, light passes through the open, cut-out part 340 of the mask 310 and is absorbed by the intact opaque portion 350 of the mask. In the current art, very little if any of the light that strikes the opaque portion of the mask is reflected because this light is absorbed, making for inefficient operation that may also generate excess and unwanted heat. The light that does pass through an opening 360 may be perceived by an observer as producing the symbol represented by the perforations made into the mask, which symbol is intended to communicate a message to a viewer.

The opening 340 in the mask 310 could contain a light-transmissive material that allows light to pass through the mask while offering protection of the light from dirt or other matter that might damage the light source. Such material could be made out of glass or plastic, for example. The light-transmissive material might also be colored, a filter, polarized, or a combination of these and other elements.

Currently, most of the light that passes through the mask opening 340 is light that is emitted directly from the light source 320, which light may also pass through an internal lens in the lamp assembly. Very little of the light that is emitted has been reflected or scattered by any other object within the lamp assembly 300. Most of the light produced by the light source 320 is emerging directly through the mask 310 as light beams that are emitted at various angles to the mask surface. Such emitted light is viewed best when the viewer is looking “on axis” at the light source 320 and thus the symbol may be interpreted most clearly when the viewer is looking on axis at the light source 320.

When a viewer looks toward the light source at an angle deviating from the substantially perpendicular directly emitted light beams, this is known by the common term of art as viewing the light source “off-axis to the light source.” As the viewer observes the light source at an angle increasingly divergent from on-axis, less of the direct light will be viewable by the viewer. Thus, the symbol becomes dimmer and less clear. The dimming of the viewable light may become more pronounced on the outer areas of the symbol due to a lesser concentration of light beams being emitted from the edge of the light source and passing through the light-transmissive outer areas of a mask.

A lamp assembly, such as the one shown in FIG. 3, contains the body of the lamp assembly, a light source, and various optical elements including, but not limited to, a distribution lens and a Fresnel lens. A distribution lens makes a light source a wider angle/lower intensity lamp. A Fresnel lens is a lens made up of concentric angular selections. The exemplary embodiments take advantage of these features.

The present invention works to increase the apparent brightness and efficiency of a lamp assembly (or full ball traffic signal) by first coating the interior of an opaque portion of a mask with a light reflecting material, emitting light from a light source such that the light impacts the mask at an opaque portion of the mask, passing light emitted directly from a light source through an aperture opening in an opaque mask, reflecting light from the coated opaque portion of a mask back into the interior of the light source, scattering the reflected light by the optical elements of the lighting source, and finally passing the scattered light through the mask at a plurality of acute angles relative to the path of the emitted light passing directly from the light source.

The coating on the mask has a high reflectivity, and the coating may consist of white paint or silver paint, which can be hand-painted on mask by a number of ways including spray painting, argent paint, vacuum-deposited metallization, co-molding, in-mold decoration, or lamination. The opposite side of the mask is a dark color with low reflectivity. The mask may be manufactured by various methods, including, but not limited to, injection molding, dye cutting, composition or vacuum molding. The mask may be made of plastic or metal. Thus, in accordance with the exemplary embodiment, the coated mask is a thin opaque part that is black (or other dark color) on one surface and reflective either in a specular or diffuse way on the other.

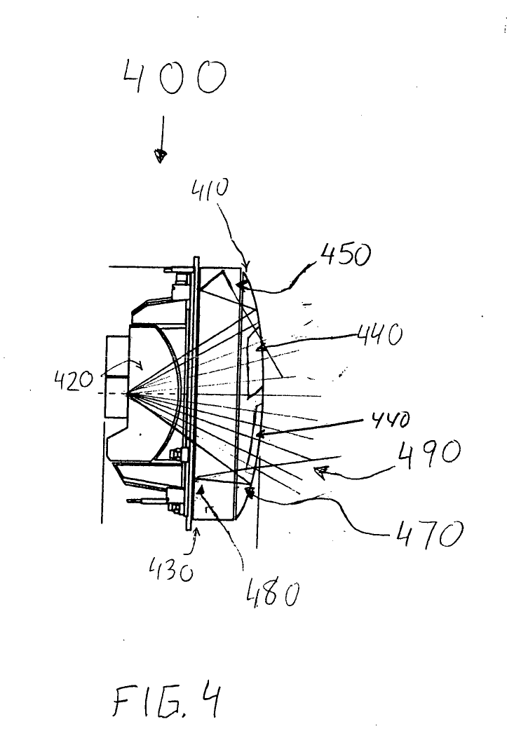

FIG. 4 illustrates an exemplary embodiment of the present invention. The lamp assembly 400 is similar to the one shown in FIG. 3. However, in this embodiment of the invention, direct light is combined with light reflected by means of a reflective coating applied to the inside of a mask 410. The light source 420 produces light toward the mask 410, which is held securely by connecting or fastening means 430. Light passes through the open, cut-out portions 440 of the mask 410. Light that strikes or falls on the mask (450) is no longer absorbed by the intact opaque portion of the mask 410. In the present embodiment, the light that was previously absorbed is now reflected off of the mask 410 and back into the lamp assembly 400. Here, the light is reflected at least one more and perhaps a plurality of times by the inner surfaces of the lamp assembly 410. This light 470 is scattered by the mask 410 and by the optical elements 480 of the lamp assembly 400, whereby it is reflected and bounces between the various lenses and surfaces of the interior of the lamp assembly 400 and the reflective coating on the mask until it escapes through the signal cut-outs 440 of the mask. The light that escapes in this way is emitted at all angles (490) as opposed to the light that is emitted by the lamp assembly 400 directly and thus radiated in a beam pattern dependant on the distribution lens. Since light from each part of the symbol is being directed to more angles, the symbol becomes more visible from broader angles and is easier to interpret. This is in contrast to conventional means wherein the most viewable aspect is the light output directly from the lamp assembly modified by the presence of the symbol cut-out.

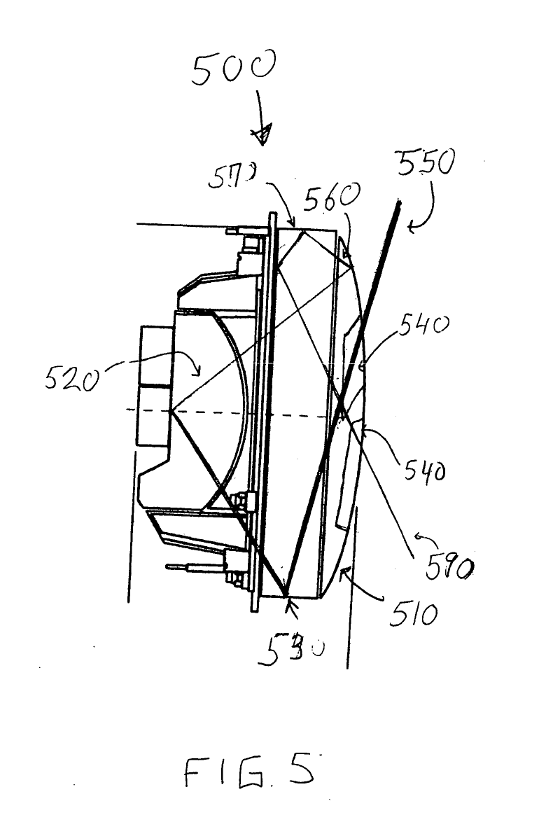

The lamp assembly 500 of FIG. 5 is similar the one shown in FIG. 4, but this figure removes the direct light beams for clarity and presents only the reflected light beams. In particular, this figure illustrates the increase in reflected light provided by adding the reflective coating to the interior of the mask 510. The mask 510 contains openings that permit direct light to exit the lamp assembly 500. Indirect light emitted from the light source 520 can reflect off of the interior components of the lamp assembly (530) and pass through the openings 540 in the mask 510 to exit from the lamp assembly (550). The reflective coating on the mask 510 further allows light 560 that strikes the mask 510 to be reflected among the interior components of the lamp (570) and pass through openings 540 in the mask 510 and eventually exit from the lamp (590).

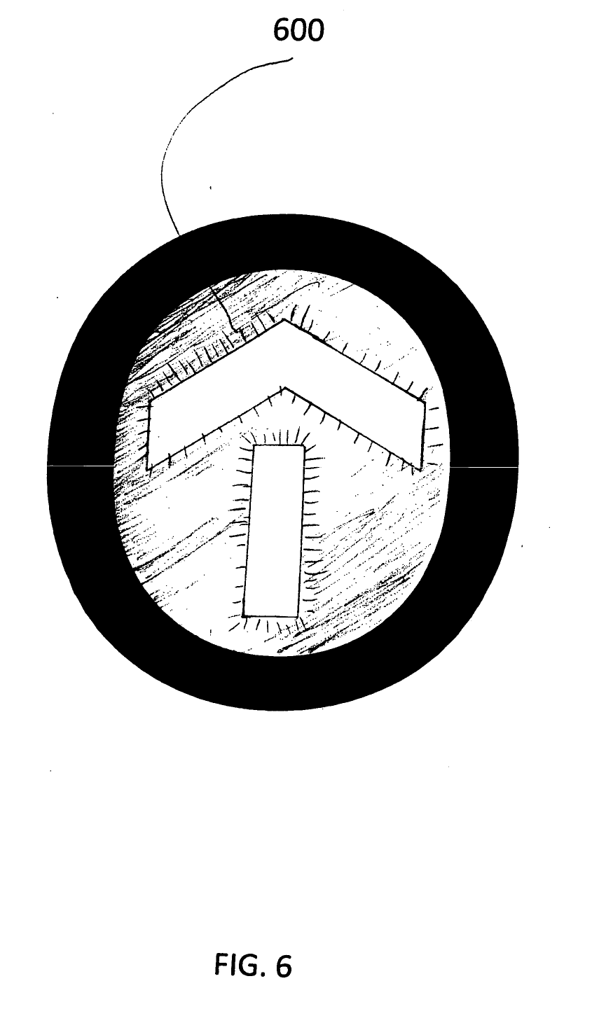

FIG. 6 illustrates the increase in the amount of light visible from the mask caused by the addition of reflected light 600 to the direct light being emitted by the mask. Prior to the addition of reflected light, most of the light that was emitted from the mask covered lamp assembly was direct light. Now with the addition of the light reflection capabilities of the mask coating, the reflected light is emitted at numerous angles and adds to the direct light, producing a brighter light that is now more easily and readily viewable by an observer seeing the lamp assembly at an off-axis angle.

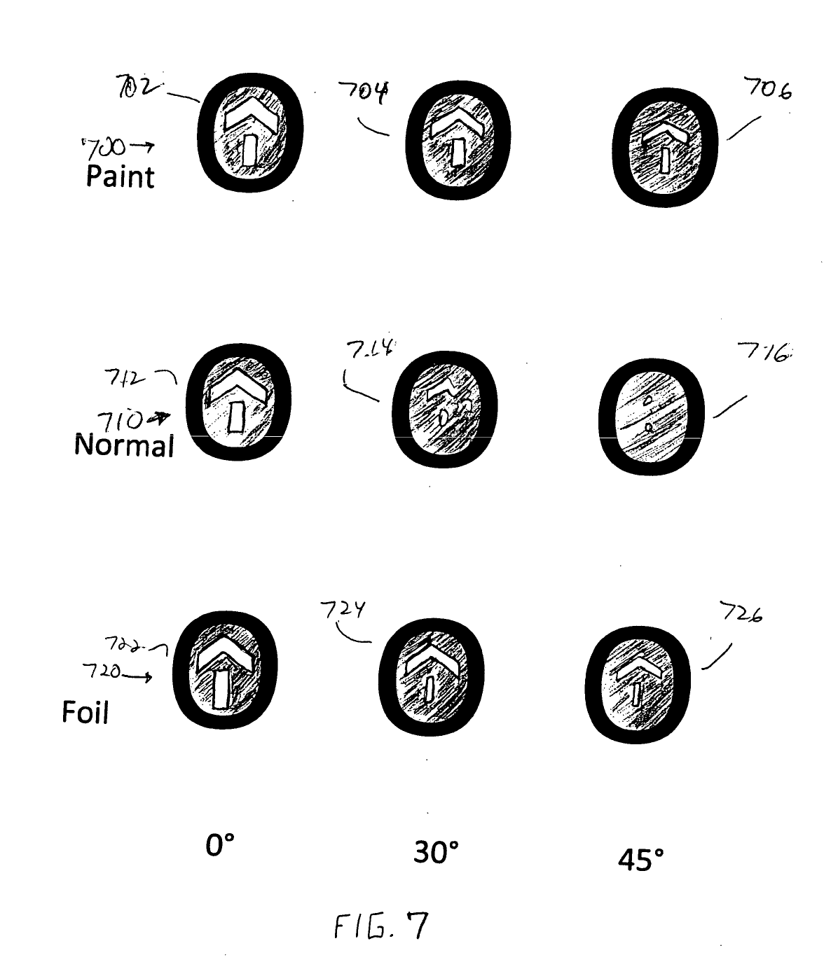

FIG. 7 is a chart that helps to illustrate the positive effects of adding a reflecting coating to a mask in accordance with the exemplary embodiments of the invention. The first row 700 represents a masked full ball signal (arrow) with a reflective coating comprising paint (702, 704, 706) viewed at three different angles—0 degrees, 30 degrees and 45 degrees. The second row 710 represents a masked full ball signal (arrow) with no reflective coating (712, 714, 716) viewed at three different angles—0 degrees, 30 degrees and 45 degrees. And finally, the third row 720 represents a masked full ball signal (arrow) with a reflective coating comprising metal foil (722, 724, 726) viewed at three different angles—0 degrees, 30 degrees and 45 degrees. As shown in the figure, when viewing the masked full ball signal at an angle that is askew or off axis, it becomes more difficult to read.

The three masks all appear to present an observer with generally the same amount of light when viewed head-on or on-axis with no angle (702, 712, 714). As the masked traffic signals are viewed off-axis (704, 706, 714, 716, 724, 726), the apparent light passing through each mask and viewable to an observer appears to be reduced. However, the masked traffic signals (arrows) produced by the coated masks (704, 706, 724, 726) appear brighter and more discernable than the traffic signals produced by the uncoated mask (714, 716). This is due to the fact that the mask currently used in the prior art does not reflect light that strikes the mask. This light is absorbed by the current non-reflecting mask technology.

The application of reflective coating or paint to the light facing side of the mask reflects light into the internal components of the traffic signal, and this reflected light is eventually reflected out of the mask at a reflected angle. This reflected light would have been absorbed and not reflected by the conventional masked signal. Therefore, a conventional masked lamp would not reflecting light and would thus appear dimmer than the coated mask, which would reflect light and appear brighter due to the addition of the reflected light to the direct light from the light source. The traffic signal using a reflective coated mask, when viewed at an off-axis angle, still appears a bit dimmer than the same traffic signal viewed on-axis; however, the addition of the reflected light makes the arrow symbol when viewed from off-axis appear substantially brighter to an observer at an angle than does the non-reflective masked traffic signal.

Thus, an advantage of the present invention is that it makes lamp assemblies (or traffic signals) easier to read for a viewer who is at a distance from the signal and allows the projected symbol to be seen further away from the lamp assembly. Since the present invention allows more light to pass from the mask-covered lamp assembly, the light may be seen at a greater distance. The inverse square law of physics states that the intensity of light varies inversely with the square of the distance from the light source, with the light appearing to be less intense as the light source and the observer move further away from each other and they are further apart relative to each other. Thus, increasing the intensity of light from a lamp assembly will also increase the distance at which the light (and thus the traffic signal) may be seen.

Another advantage of the present invention is that it improves the visibility of the signal when viewed from an angle askew from head on, such as at a 30 or 45 degree angle. The light that is viewed from an askew angle is augmented by the reflected light, which emerges at an angle from the mask pattern.

Another advantage of the present invention is that the mask in use does not become as hot as similar masks because the light energy is reflected and not absorbed to be turned into heat energy.

Alternatively, the reflective coating could be applied to one or more of the optical elements in the lamp assembly instead of the mask.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

What is claimed is:

1. A lamp assembly comprising:
a solid, opaque panel perforated by a plurality of apertures producing a silhouetted symbol representative of a traffic or pedestrian message;
a reflective coating affixed to the light-facing inner side of the panel that reflects light;
at least one optical element that scatters the reflected light through the mask at a plurality of angles relative to the path of the emitted light passing directly from the light source; and
a low reflective, dark colored layer affixed to the outer side of the mask in order to provide contrast with the light passing through the pattern of apertures.

2. The lamp assembly of claim 1, wherein the apertures are formed by the removal of materials from the aperture area.

3. The lamp assembly of claim 1, wherein apertures are composed of a light-transmissive material.

4. The lamp assembly of claim 3, wherein the light-transmissive material is colored or filtered.

5. The lamp assembly of claim 1, wherein the optical elements comprise at least one of a distribution lens and a Fresnel lens.

6. The lamp assembly of claim 1, wherein the reflective coating is one of white, silver or argent colored.

7. The lamp assembly of claim 1, wherein the reflective coating is one of a vacuum-deposited metallization, a co-molding, an in mould decoration, or a lamination.

8. A method of increasing the brightness and efficiency of a lamp assembly, the method comprising:
coating the interior of an opaque portion of a mask with a light reflecting material;
passing light emitted directly from a light source through a plurality of aperture openings in an opaque mask;
emitting light from a light source such that the light impacts the mask on an opaque portion of the mask;
reflecting light from the coated opaque portion of a mask back into the interior of the light source;
scattering the reflected light by the optical elements of the light source; and
passing the scattered light through the mask at a plurality of angles relative to the path of the emitted light passing directly from the light source.

9. The method of claim 8, wherein the apertures are formed by the removal of all materials from the aperture areas.

10. The method of claim 8, wherein the apertures are composed of a light-transmissive material.

11. The method of claim 8, wherein the light-transmissive material is colored or filtered.

12. The method of claim 8, wherein the optical elements comprise at least one of a distribution lens and a Fresnel lens.

13. The method of claim 8, wherein the reflective coating is one of white, silver or argent colored.

14. The method of claim 8, wherein the reflective coating is one of a vacuum-deposited metallization, a co-molding, an in mould decoration, or a lamination.

15. A system comprising:
at least one light source;
a plurality of optical elements;
at least one opaque covering containing a plurality of apertures; and
a reflective substance applied to the interior of the opaque covering or to at least one of the optical elements.

16. The system of claim 15, wherein the apertures are formed by the removal of all materials from the aperture areas.

17. The system of claim 15, wherein the apertures comprise a light-transmissive material or is colored or filtered.

18. The system of claim 15, wherein the optical elements comprise at least one of a distribution lens and a Fresnel lens.

19. The system of claim 15, wherein the reflective coating is one of white, silver or argent colored.

20. The system of claim 15, wherein the reflective coating is one of a vacuum-deposited metallization, a co-molding, an in mould decoration, or a lamination.

21. A mask for a lamp assembly comprising:
a solid, opaque panel perforated by a plurality of apertures producing a silhouetted symbol representative of a traffic or pedestrian message;
a reflective coating affixed to the light-facing inner side of the panel that reflects light; and
a low reflective, dark colored layer affixed to the outer side of the mask in order to provide contrast with the light passing through the pattern of apertures.

22. The mask of claim 21, wherein the apertures are formed by the removal of materials from the aperture areas.

23. The mask of claim 21, wherein the apertures are composed of a light-transmissive material.

24. The mask of claim 23, wherein the light-transmissive material is colored or filtered.

25. The mask of claim 21, wherein the reflective coating is one of white, silver or argent colored.

26. The mask of claim 21, wherein the reflective coating is one of a vacuum-deposited metallization, a co-molding, an in mould decoration, or a lamination.
